(19) United States
(12) Patent Application Publication
(10) Pub. No.: US 2006/0275632 A1
(43) Pub. Date: Dec. 7, 2006

(54) Auxiliary battery

(76) Inventor: Kyoung Hae Kim, Los Angeles, CA (US)

Correspondence Address: KYOUNG HAI KIM, 146 DOUGLAS ST #10, LOS ANGELES, CA, 90026, US

(21) Appl. No.: 11/142,763

(22) Filed: Jun. 1, 2005

(51) Int. Cl. H01M 2/34

(52) U.S. Cl. 429/9; 429/61

(57) ABSTRACT

When the main battery is exhausted temporarily, the auxiliary battery give impact power current to main battery, without impact power current can not start up the engine. (21v−15v)×(19A−15A0, (like these some, direct connection circuit capacity, or parallel circuit capacity) auxiliary battery (for 24v or 12v) impact power current directly go to the main battery, and running engine is making generator working, which give electric power current to the main battery become normal condition. And for more safety, at the auxiliary battery, water bubble fuse is installed and, with feeling thermoelectric current stick metal is stuck up under the center of bimetal device and furrowed chemical proof & fire proof material wrap on all around the auxiliary battery, these are making more safety in case of explosion. And then we can take care of usually using fittable amount of fuse, (V×A×60%×2).

### FIELD OF THE INVENTION

In case of emergency situation and hurry up should go some where after solving the problem (main battery exhausted temporarily). the auxiliary battery is really needed. the auxiliary battery can help main battery which is exhausted temporarily; the vehicle can be started up immediately by using auxiliary switch and turning on engine starting key.

We can use only just button so save effort and safety.

### BACKGROUND ART

Without running engine, some light on or any light on long time, become the main battery is too low power condition, so we can not start up the engine by only main battery, like this occasion auxiliary battery give impact power current to main battery and help to start up the engine together with main battery, and the generator working gives electric power current to the main battery and so main battery become normal condition.

But we have to use auxiliary battery safety, so some idea is added, for example, water babble fuse and bimetal device, feeling thermoelectric current stick metal, and furrowed chemical proof & fire proof material.

### BRIEF SUMMARY OF THE INVENTION

When the main battery is temporarily exhausted, this auxiliary battery (some occasion, parallel circuit capacity, or direct connection circuit capacity) give to main battery impact power current, without impact power current the engine can not be started up, and then main battery and auxiliary battery help together, that make engine running. And running engine make the generator working, that make main battery normal condition.

And if in case, exact vehicle repair, and look about detail, and cautious about trying to get no mistake, we are just needed only fittable amount of fuse. But if sometime, somebody make mistake in the connection of the auxiliary battery, from auxiliary battery, through special button switch (for preventing natural electric discharge) to the main battery, it is a big problem. For example, short circuit, main battery terminal is not tight.

Like these cases make resistance increasing, and usually the fittabble amount of fuse can take care like these cases, but direct connection of fuse and increasing resistance of untight and the other uncautious mistake, is a cause of auxiliary battery explosion.

So, for more absolutely safety, water bubble fuse and bimetal device is installed at the auxiliary battery. and then some more safety, chemical proof & fire proof material wrap on whole around the auxiliary battery.

And then we can take care of usually using fittable amount of fuse, (V×A×60%×2).

### BRIEF DESCRIPTION OF THE DRAWINGS

This auxiliary battery is so smaller than main battery that can be set up easy way to proper place.

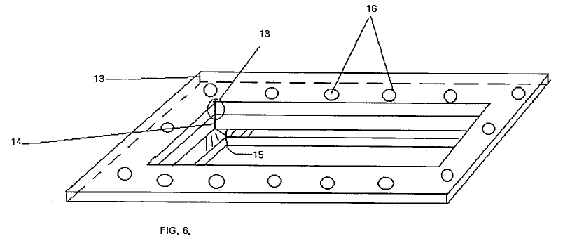

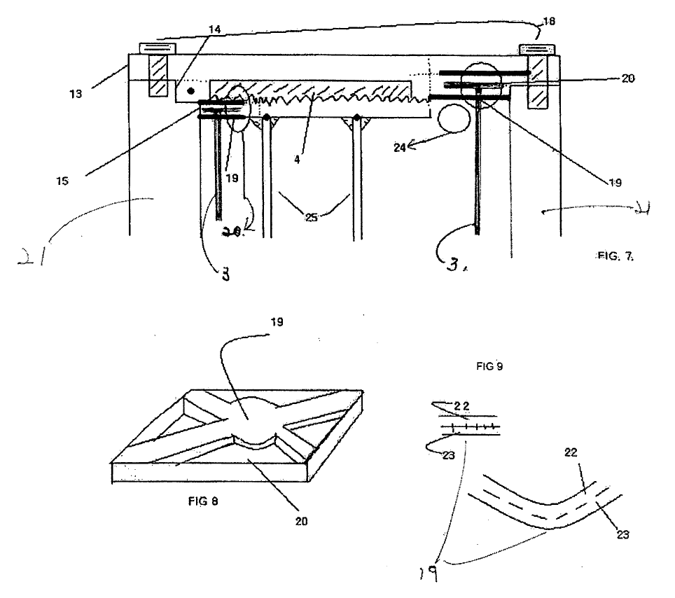

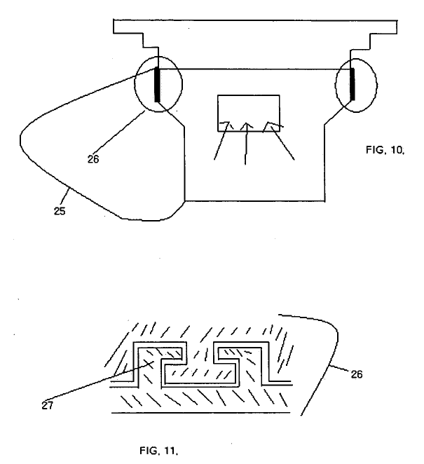

For safety we have to use water bubble fuse and bimetal device by combination (FIG. 7., FIG. 8., FIG. 9.), and proper amount of fuse at the plus electric line, (FIG. 3.).

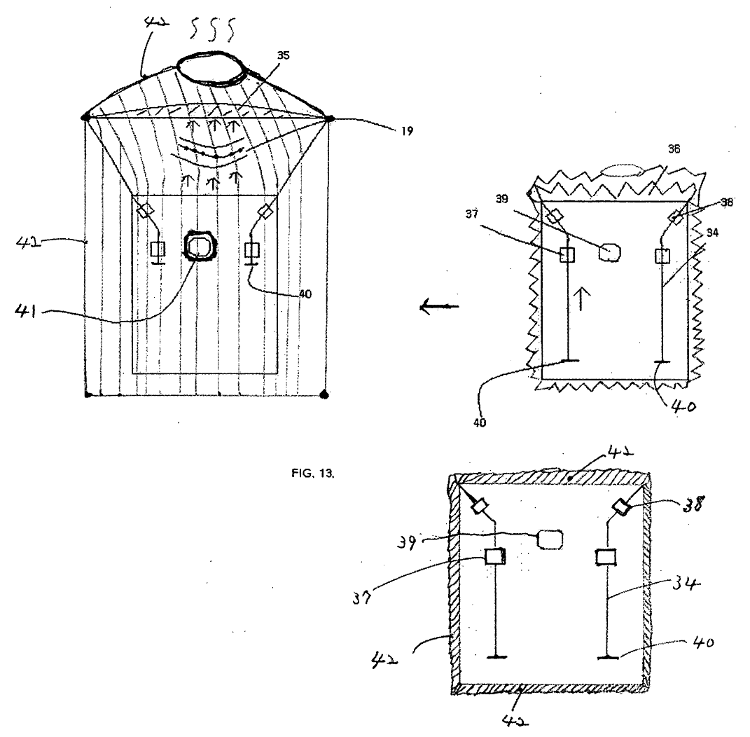

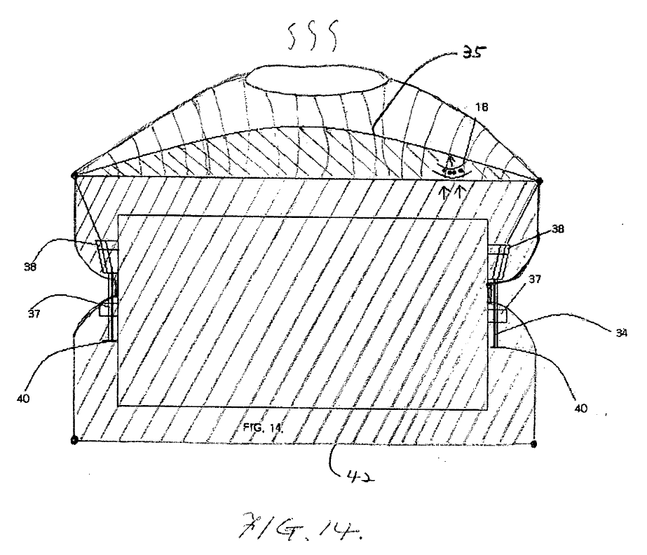

And for more safety, at the auxiliary battery, furrowed chemical proof & fire proof material wrap on whole around the auxiliary battery, (FIG. 13., FIG. 14.), these are making more safety incase of explosion.

### REFERENCE NUMERALS IN DRAWINGS

3 easy way feeling thermoelectric current string metal. (FIG. 7.)
4 water bubble fuse. (FIG. 7.)
5 main battery 6 auxiliary battery button switch
7 vehicle 8 the auxiliary battery go to fittable place in the vehicle.
9 (+, −) line go to main battery 10 by button switch go on the dash board.
11 fuse, (21v−15v) 12 fuse box go to fittable place. ×(19A×−15A)×60%×2
13 hard cover 1st step thickness. 14 hard cover 2^{nd} step thickness.
15 hard cover 3^{rd} step thickness. 16 bolt role. (fourteen)
17 for preventing leaking iron gasket. 18 bolt
19 bimetal 20 bimetal portion.
21 container side wall. 22 less feeling heat metal than 23
23 feeling heat sensitive more than 22.
24 empty space
25 2 plate inside stick up the hard cover
26 get a protrusion portion so, with 27, 27 strong holder & lock, sustain center of the auxiliary battery center of the wall of the container.
28 electrolyte (+). 29 electrolyte (−).
30 − ion 31 + ion
32 electrolysis liquid 33 electrolyze
34 wire for No.36, No.35, 35 fire proof & chemical proof spread by bursting up material, spread by bursting bimetal portion and up bimetal portion and water bubble fuse water bubble fuse. Just like umbrella.
36 No. 35 portion is folding 37 wire straight guider
38 wire bending guider 39 end of minus terminal
40 end of wire 41 end of plus terminal
42 for prevention to spread and leaking, whole around the auxiliary battery is wrapped and folded, and folded portion is laid on the side

### DETAILED DESCRIPTION OF THE INVENTION

FIG. 1. is the connection of the auxiliary battery (from auxiliary battery, through button switch, to the main battery).

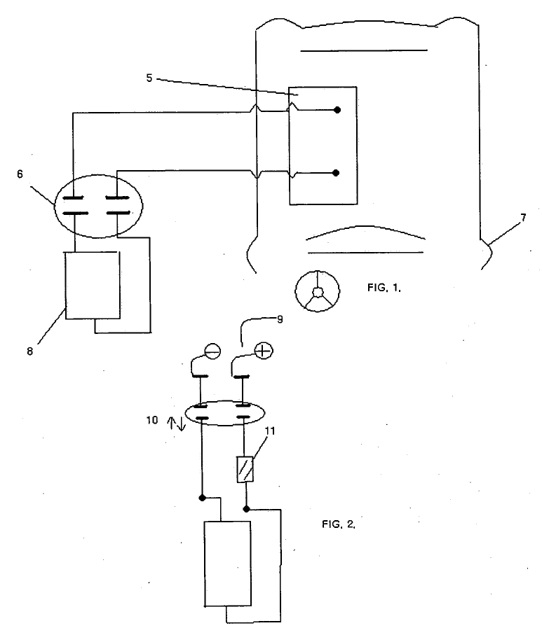

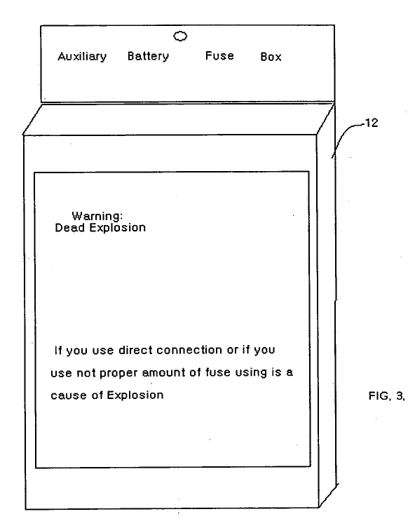

FIG. 2. is showing how to use of fuse, (21v−15v)×(19A−15A)×60%×2, like these amount of fuse should be installed at the electric plus line and this fuse should be installed special fuse box, not regular fuse box, just like FIG. 3., because auxiliary battery could be serious exploded.

FIG. 3. should be installed separately with regular fuse box because regularly auto mechanics have a habit to direct connection of a fuse for finding with some electrical problem. And then put in fuse is safety, but some time forget using fuse is a cause of big problem. So let them know and warning specially and make safety, so we have to use this auxiliary battery fuse box separately.

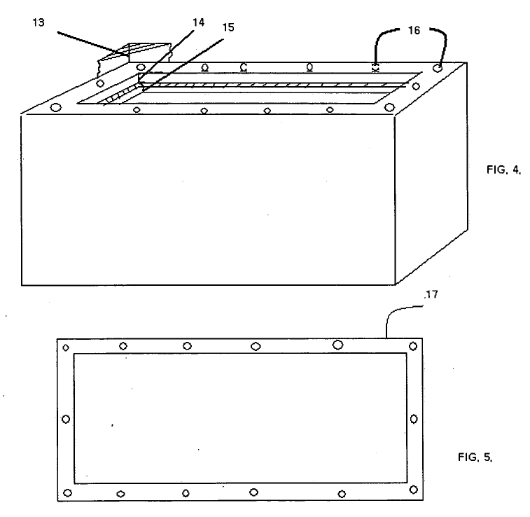

FIG. 4. is a container which has fourteen bolt hole and be put in electrolysis liquid and has two poles of electrolyte, those are (minus pole, plus pole) electrolyzed, so get a electric power and could be auxiliary battery.

FIG. 5. is, for preventing leaking, iron gasket.

FIG. 6. is a hard cover of the container and has fourteen bolt hole.

FIG. 7. is the cross section of hard cover and container, 24 portion is empty space, and just like drawing, 3 is, feeling heat stick metal (the other expressions is, feeling thermoelectric current stick metal). 3 is stuck up at the center of bimetal device. Short circuit or not tightly connected terminal and direct connection instead of fuse, these are a cause of auxiliary battery exploding. Like these cases, before explosion, 3 is feeling heat and heat is transferred to 19, 20 portion and 19 (bimetal device) is bending, 20 (bimetal device portion) is broken, and then both side of 4 (water bubble fuse) is broken. And so near both (+, −) terminal side, electrolyzing will be very much slow, it makes the heat come down.

FIG. 8. is about bimetal device. 20 is a bimetal installed portion, 19 is a bimetal.

FIG. 9. shows how to work bimetal. 19 is bimetal, 22 and 23 is different feel of heat and so can break 20 portion.

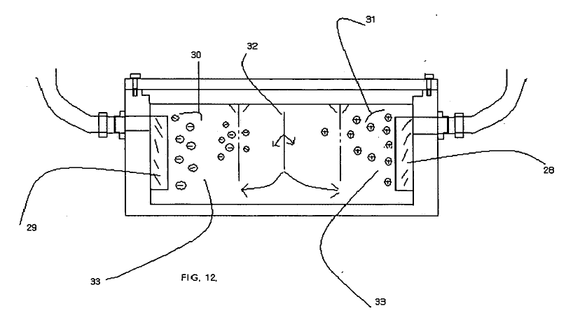

FIG. 10. is, as shown in FIG. 7., 25 portion. And 2 plate is at inside the container (as shown in FIG. 7.). By 26 portion, by 25, (as shown in FIG. 11.), is sustaining strongly the hard cover of the container center.

FIG. 11. is at the position of 25 (as shown in FIG. 7.) and (FIG. 10.), strong holder and lock at the 26 portion (FIG. 10.). 26 portion is at the plate 25, and 27 portion is at the side wall of the container.

FIG. 12. is showing electrolysis liquid is electrolyzed by electrolyte, and minus ion and plus ion go to the end of both terminal, and gathers together, and battery get a electric power.

FIG. 13. is showing, when the bimetal device is broken and water bubble fuse is broken, the bimetal portion is bursting up 35, 36, 42 prevent to spread liquid; by 35, 36, 42 (chemical proof & fire proof material) the auxiliary battery is wrapped on whole around and folded and folded portion is laid on the side.

FIG. 14. is showing front of auxiliary battery when the bimetal device is bursting up and water bubble fuse is broken up. And whole around auxiliary battery is wrapped on by chemical proof & fire proof material. 35 is spread just like an umbrella and 42 wrap on more out side and prevent leaking. and water bubble fuse is broken up, it catch out toxic, catch out flammable, and counter act surroundings.

### CONCLUSION, RAMIFICATION, AND SCOPE

The auxiliary battery is smaller than main battery that can be set up at proper place easy way. In case of emergency situation and hurry up should go somewhere after solving the problem (main battery exhausted temporarily), the auxiliary battery is really needed.

The auxiliary battery can help main battery which is exhausted temporarily, the auto vehicle can be started up immediately by using auxiliary battery switch and turning on the starting key.

At the auxiliary battery, is installed water bubble fuse and, with feeling thermoelectric current stick metal is stuck up under the center of bimetal device, and furrowed chemical proof & fire proof material wrap on all around the auxiliary battery, these are making more safety in case of explosion.

And then we can take care of usually using fittable amount of fuse, (v×A×60%×2).

What is claimed is:

1. a method comprising the stops of:
Providing a main battery in an automotive vehicle;
Providing an auxiliary battery in the automotive vehicle;
Wherein when the main battery becomes temporarily exhausted, for escaping serious dead explosion,
using water bubble fuse and bimetal device at the auxiliary battery, in order to give impact power current to main battery from auxiliary battery,
depressing, a button to connect the auxiliary battery to load in the vehicle to supply current, and then running engine and generator working give to main battery current, so vehicle become normal condition and for preventing to spread bursting up thing,
using furrowed chemical proof & fire proof material at the whole around the auxiliary battery,
Wherein we can make the auxiliary battery more safety.
